(19) United States
(12) Patent Application Publication
(10) Pub. No.: US 2023/0065162 A1
(43) Pub. Date: Mar. 2, 2023

(54) PET WASTE APPARTUS, SYSTEM, AND METHOD

(71) Applicant: Clinton Daniel Miller, Jacksonville, FL (US)

(72) Inventor: Clinton Daniel Miller, Jacksonville, FL (US)

(21) Appl. No.: 17/823,664

(22) Filed: Aug. 31, 2022

Related U.S. Application Data
(60) Provisional application No. 63/260,848, filed on Sep. 2, 2021.

(51) Int. Cl. A01K 1/01

(52) U.S. Cl. CPC A01K 1/0107

(57) ABSTRACT

A pet waste apparatus, system, and method embodying an outdoor, ground-based litter-free pet commode providing sheltered access to a larger structure of the pet owner. The pet commode defines an enclosed area having a lower portion defined by a depth of ground removed and replaced with a layer of gravel and/or sand acting as a waste medium. The outdoor pet commode provides an external conduit coupled to an egress to the enclosed area so that a pet may move from the outdoor pet commode to an interior space of a larger structure without being exposed to the external environment.

### CROSS-REFERENCE TO RELATED APPLICATION

This application claims the benefit of priority of U.S. provisional application No. 63/260,848, filed 2 Sep. 2021, the contents of which are herein incorporated by reference.

### BACKGROUND OF THE INVENTION

The present invention relates to pet accessories and, more particularly, a pet waste apparatus, system, and method embodying an outdoor, ground-based litter-free pet commode providing sheltered access to a larger structure of the pet owner.

Pet litter boxes are odious and require frequent cleaning. The cost of litter is a regular expense to cat owners, that these days seems to get more and more expensive. Current outdoor pet waste apparatuses become less appealing as the weather deteriorates because current solutions lack a sheltered pet access and need regular cleaning. Current devices do not provide a ground-based, outdoor, permanently mounted structure that provides secure pet access.

As can be seen, there is a need for a pet waste apparatus, system, and method embodying an outdoor, ground-based litter-free pet commode providing sheltered access to a larger structure of the pet owner. The pet commode is an enclosure adjunct to a larger structure of the pet owner, wherein the pet commode is adapted so that cleaning frequency, odorous smells and even the need for litter are eliminated.

The present invention is more solidly constructed relative to the prior art, and ground mounted to withstand severe weather conditions. It also provides secured (interior to exterior) pet access, in effect a gateway for the pet to move between an enclosed environment of the pet commode to an enclosed environment of a larger structure so as to obviate the need to be outside. The device embodied in the present uses a lower-cost base material and more significantly reduces service cleaning over current devices. The device mounts outside a larger structure, such as a home or pool area, and directly attaches via at least one pet door. The present invention utilizes sand as a base material, and thereby eliminates the need for litter.

### SUMMARY OF THE INVENTION

In one aspect of the present invention, an outdoor ground-mounted pet commode includes: a plurality of sidewalls defining an enclosed area; a roof defining an upper surface of the enclosed area, the roof pivotably attached to an upper portion of the plurality of sidewalls; and a void in the ground defining a lower surface of the enclosed area; a void depth of said void being at least six inches from a ground level immediately surrounding the enclosed area; and a layer of sand occupying the void, wherein the layer of sand has a depth between approximately six and approximately eight inches, whereby the layer of sand provides a biodegradable environment for fluid waste drainage and solid waste breakdown.

In another aspect of the present invention, the outdoor ground-mounted pet commode further includes the following: at least one egress formed in the plurality of sidewalls; and a conduit coupled to each egress, wherein the conduit is coupled to a larger interior environment; further including a layer of gravel between the layer of sand and the lower surface of the enclosed area, wherein the layer of gravel has a depth of approximately two to three inches; further including a barrier plate extending vertically downward from a lower portion of the plurality of sidewalls into the ground a distance greater than the void depth; further including one or more vents in the plurality of sidewalls.

In yet another aspect of the present invention, the method of providing an outdoor, ground-mounted pet commode, the method includes the following: driving a barrier plate into ground at least six inches; digging a void in the ground at least six inches below ground level; building an enclosed area over the void; and connecting the enclosed area to an interior environment of another larger structure by way of a conduit dimensioned and adapted to enable a cat-sized animal to pass through the conduit.

These and other features, aspects and advantages of the present invention will become better understood with reference to the following drawings, description and claims.

### BRIEF DESCRIPTION OF THE DRAWINGS

FIG. 1 is a top perspective view of an exemplary embodiment of the present invention.

FIG. 2 is a side elevation view of an exemplary embodiment of the present invention.

FIG. 3 is an exploded perspective view of an exemplary embodiment of the present invention.

FIG. 4 is a section view of an exemplary embodiment of the present invention, taken along line 4-4 in FIG. 1.

FIG. 5 is a side elevation view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a pet waste apparatus, system, and method embodying an outdoor, ground-based litter-free pet commode providing sheltered access to a larger structure of the pet owner. The pet commode defines an enclosed area having a lower portion defined by a depth of ground removed and replaced with a layer of gravel and/or sand acting as a waste medium. The outdoor pet commode provides an external conduit coupled to an egress to the enclosed area so that a pet may move from the outdoor pet commode to an interior space of a larger structure without being exposed to the external environment.

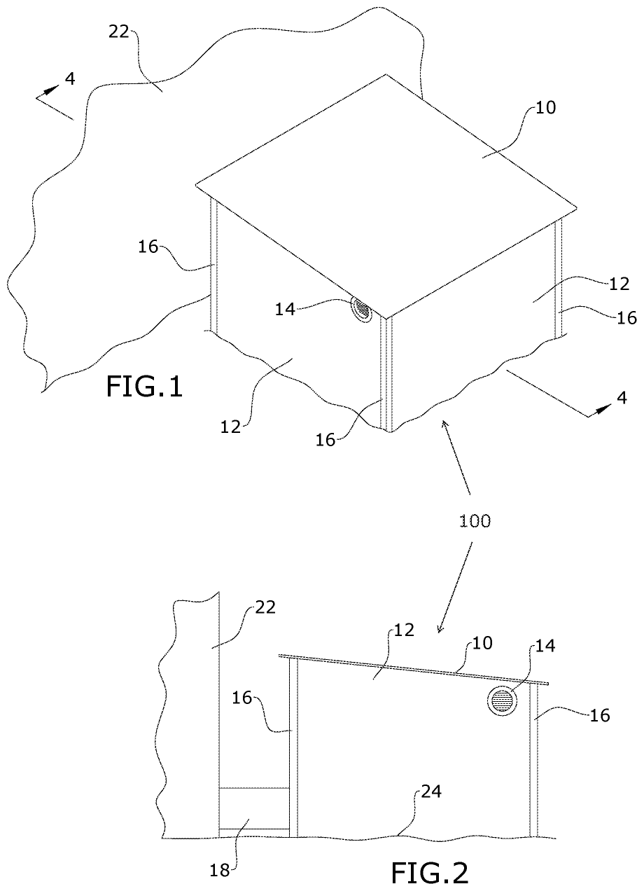

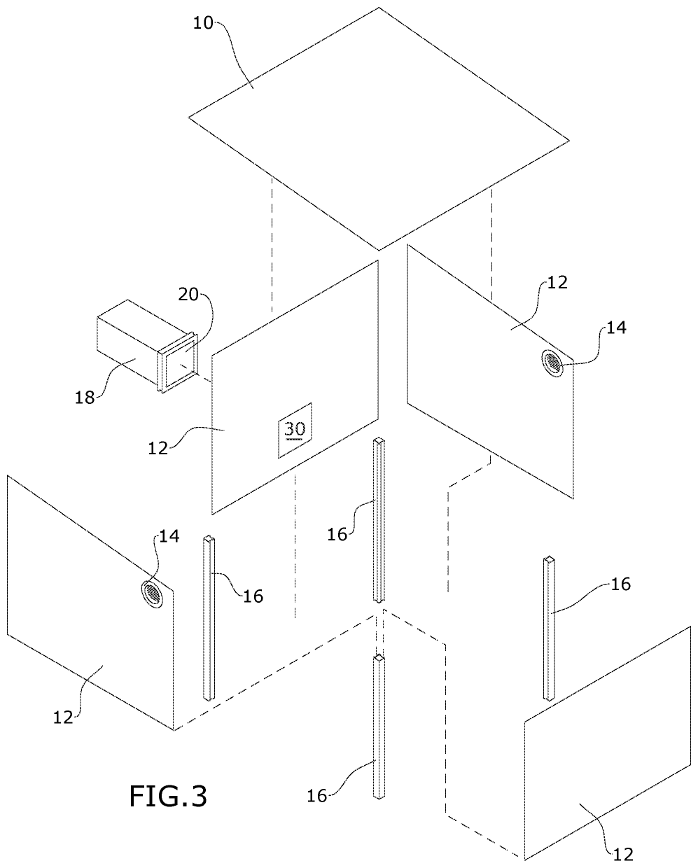

Referring now to FIGS. 1 through 5, the outdoor, ground-mounted pet commode 100 has a plurality of sidewalls 12 defining an enclosed area 50. Posts 16 may be embedded in the ground 24 to support the plurality of sidewalls 12. One or more vent 14 may be provided through the plurality of sidewalls 12.

The ground 24 defines the bottom of the enclosed area 50, and a roof 10 connected along an upper edge of the plurality of sidewalls 12 defines the top of the enclosed area 50. The roof 10 is moveable between an open position and a closed position sealing off the top of the enclosed area 50.

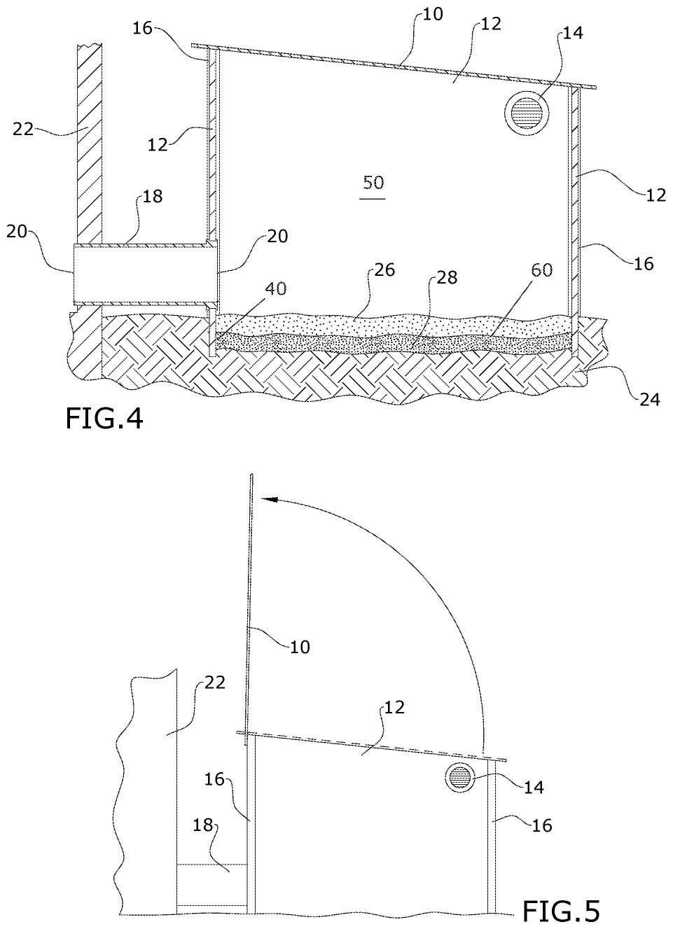

The ground 24 of the enclosed area 50 may be covered with a layer of gravel 28. The depth of the layer of gravel 28 may be approximately eight inches or less. The layer of gravel 28 may be covered with a layer of sand 26. The depth of the layer of sand 26 may be approximately three inches or less. The sand 26 and/or gravel 28 act as a (urinary or solid) waste medium. In certain embodiments, a permeable membrane 60 may be disposed goes between the sand and gravel layers 26 and 28, as illustrated in FIG. 4, thereby keeping the two substrates from mixing.

The ground 24 may be dug out by a dug depth to enable the thermal energy of the ground to permeate the enclosed area 50 as well as support the layers of sand and/or gravel 26 and 28. The dug depth may be approximately ten inches so that an upper surface of the layer of sand 26 is substantially at the same elevation as an upper surface of the ground 24 immediately surrounding the pet commode 100. Generally speaking, the depth of the layer of sand 26 and the depth of the layer of gravel would be determined, in part, by the outside topography or drop of the property.

An egress 30 may be formed in at least one of the plurality of sidewalls 12 so that a conduit 18 may be coupled to the egress 30 so that a pet (not shown) can move from the enclosed area 50 to an interior environment of a larger structure 22 of the pet owner. A pet door 20 may cover the egress 30 so that movement through the egress 30 can be selectively prevented. In some embodiments, the enclosure area 50 may provide an additional access point in addition to the egress 30 to communicate the enclosed area 50 and the interior space of the larger structure 22. The pet door 20 may be configured to magnetically close, while a door attachment device includes a rubberized gasket or the like. The pet door 20 may be at only the access point/egress 30 communicating the enclosed area 50 to the exterior thereof. Each pet door 20 may be installed on a house or pool side wall, wherein each pet door 20 may include a spacing gasket used for connection between it and the adjacent wall.

The structure of the pet commode 10 may have framework and ground penetrating barriers made of corrosion resistant aluminum. Framework connecters and hinges may be made of corrosion resistant material as well, while the walls and roof may be synthetic boards or other durable, weather-resistant material. The framework for the structure's body and roof may be fastened together with connectors, and the structure's walls may slide into framework grooves, while the roof is fastened down from top with a pivotable connection, like a hinge. A plurality of barrier ground penetration plates 40 may be sunk into the ground to create an underground barrier. The depth of the ground penetrating plates 40 would be determined, in part, by the outside topography or drop of the property.

In certain embodiments, a method of installing the present invention may include the following. The framework constructed and the corner posts 16 are buried into the ground 24 if desired (recommended). The barrier walls 40 may be sunk into the ground 24 around the interior base framework to limited intrusion or extrusion of materials and unwanted guests. The walls 12 may be slid into grooved spaces and roof 10 attached to the hinged portion of the framework for the roof 10 to move between a closed position and an open position for servicing, as illustrated in FIG. 5. The pet door may be installed providing access to an exterior house wall or pool cage with a gasket connector depending on the application needs of the homeowner.

The homeowner may then pour in locally purchased play sand until a depth of approximately 6″ to 8″ inches is reached (clay-based environments may require approximately 2″ to 3″ of base gravel under the sand level). There is no actual “floor” to the device. The sand, gravel, or the like may provide the bottom of the apparatus and as a result creates a biodegradable environment for fluid drainage and solid mass breakdown, which is critical to why the present invention seldom needs to be cleaned.

Once the various aluminum materials and synthetic wall/roof and pet door/gasket application materials are procured specific design cutting is performed based on size needs of the final device required by the installer. All listed device materials may be needed for basic function. Optional additions include but are not limited to 1) a pet door automation controlled by collar worn by pet; and 2) an electric driven fan-based ventilation system (110v or solar)

Multiple variations can be applied using component parts, including different overall size and shape of the structure and the enclosure. For example, the device can be corner mounted, free standing without home connection. Multi-directional pet access points can be used. This device can be adapted for concrete floored patio use but an actual litter container would be necessary to serve as the bottom. The enclosed area may be substantially larger or substantially smaller than the following exemplary dimensions: a length of forty-two inches, a width of thirty inches, and a height of twenty-four inches.

A method of using the present invention may include the following. Once the apparatus 100 is constructed and base medium 28/26 is added, all that is needed to use the device is to introduce the pet(s) as one would a regular indoor litter box. Users may be instructed to periodically raise the roof 12 of the device 100 in the beginning to check usage volume and to gain a feel for how often it needs to be renewed. It is recommended that at least one to two times per year that some of the top material 26 of base medium be removed and replaced with new sand. This could be more frequent if use is heavy. Additionally, the present invention may be adapted for pet containment.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. An outdoor ground-mounted pet commode comprising:
a plurality of sidewalls defining an enclosed area;
a roof defining an upper surface of the enclosed area, the roof pivotably attached to an upper portion of the plurality of sidewalls; and
a void in the ground defining a lower surface of the enclosed area;
a void depth of said void being at least six inches from a ground level immediately surrounding the enclosed area; and
a layer of sand occupying the void, wherein the layer of sand has a depth between approximately six and approximately eight inches,
whereby the layer of sand provides a biodegradable environment for fluid waste drainage and solid waste breakdown.

2. The outdoor ground-mounted pet commode of claim 1, further comprising:
at least one egress formed in the plurality of sidewalls; and
a conduit coupled to each egress, wherein the conduit is coupled to a larger interior environment.

3. The outdoor ground-mounted pet commode of claim 2, further comprising a layer of gravel between the layer of sand and the lower surface of the enclosed area.

4. The outdoor ground-mounted pet commode of claim 3, wherein the layer of gravel has a depth of approximately two to three inches.

5. The outdoor ground-mounted pet commode of claim 4, further comprising a barrier plate extending vertically downward from a lower portion of the plurality of sidewalls into the ground a distance greater than the void depth.

6. The outdoor ground-mounted pet commode of claim 5, further comprising one or more vents in the plurality of sidewalls.

7. A method of providing an outdoor, ground-mounted pet commode, the method comprising:
driving a barrier plate into ground at least six inches;
digging a void in the ground at least six inches below ground level;
building an enclosed area over the void; and
connecting the enclosed area to an interior environment of another larger structure by way of a conduit dimensioned and adapted to enable a cat-sized animal to pass through the conduit.
